(19) United States
(12) Patent Application Publication
(10) Pub. No.: US 2007/0207023 A1
(43) Pub. Date: Sep. 6, 2007

(54) Forklift truck

(76) Inventor: Eric O'Keeffe, Monaghan (IE)

Correspondence Address: HOFFMANN & BARON, LLP, 6900 JERICHO TURNPIKE, SYOSSET, NY, 11791, US

(21) Appl. No.: 11/713,867

(22) Filed: Mar. 5, 2007

(30) Foreign Application Priority Data
Mar. 3, 2006 (IE) S2006-0159

(51) Int. Cl. B66F 9/18

(52) U.S. Cl. 414/619

(57) ABSTRACT

A forklift (1) for the loading and unloading of goods comprises a pallet truck (100) and an outrigger, wherein the pallet truck (100) is adapted for detachably coupling to said outrigger (200) via a tilting connection carriage (208). The tilting connection carriage (208) is raised and lowered by a lifting carriage (203) that is slidably mounted on lift masts (204) provided on outrigger (200) such that pallet truck (100) can be elevated to a desired working level from where it can detach from tilting connection carriage (208) and travel onto a raised platform such as the bed (901) of a truck (900). Motion of the outrigger (200), which is provided with a separate motive power means from pallet truck (100), is controlled by an operator seated within pallet truck (100). The forklift (1) is further provided with a means (950) of mounting and securing to a delivery vehicle (900).

The present invention relates to a forklift for the loading and unloading of a delivery vehicle or ISO freight container, preferably a truck-mounted forklift.

In the logistics industry companies continually strive for efficient distribution and delivery of their goods and in addition to demanding economic and time constraints such companies face numerous other operating and regulatory constraints with which they must comply. In the urban environment these issues are of particular importance as the negative impact of current freight practices on the quality of life in cities has been identified. With changes in urban infrastructure and policy resulting in reduced city access, pedestrian zones and increasing parking and access time regulations it has become necessary for goods transporters to re-assess the way in which urban freight is planned and managed. Stemming from these issues European Union initiatives and incentives have been established to compile best practice city logistics solutions and to find new and innovative ways to distribute goods in cities while reducing road congestion and to address other important topics which include night time and out of hours deliveries, sensitive delivery locations and unmanned delivery locations.

In the burgeoning market of ‘city distribution’ whereby goods are delivered from box body rigid trucks to shops, supermarkets, public houses and other similar retail establishments, delivery vehicles are usually equipped with tail lifts for loading and unloading goods. The vast majority of these goods are palletised and are unloaded from the delivery vehicle using a manual or electric pallet truck in conjunction with the tail lift. Currently this is the only suitable way to unload a box body truck. While the manual or electric pallet trucks used in this approach work well for moving relatively light loads over smooth level surfaces, they are not suitable for moving heavy loads over sloped rough surfaces such as roads and footpaths. Other limitations to this approach include the need to park the delivery vehicle close to the delivery site and the frequent necessity of additional personnel to force laden pallet trucks over broken or uneven footpaths and increasing concerns over personal injuries associated with manual handling and use of pallet trucks with tail lifts. An alternative method to unload vehicles is the conventional truck mounted forklift. However as they are unable to enter a box body to unload goods therein their use is only suitable for flat bed or curtain sided trucks and trailers. A further disadvantage to their use is that access is only gained via the sides of the truck which may cause traffic disturbances in a city or roadside location. A further method to unload a truck is provided by truck mounted cranes. However these are more commonly used to unload building products and their used is limited to flat bed trucks and trailers and suffer the disadvantage of not being able to deliver the payload to any great distance removed from the vehicle.

It is therefore an object of the invention to alleviate the disadvantages associated with the prior art.

The invention is particularly claimed in the appended claims which are incorporated herein.

Accordingly, the present invention provides a forklift comprising;

an outrigger having motive power means and a plurality of ground engaging wheels;

a pallet truck mounted on the outrigger, the seated pallet truck having motive power means and a pair of forks or other means for engaging a load and a separate set of wheels;

means for raising and lowering the pallet truck relative to the ground engaging wheels of the outrigger; and means for disengaging and re-engaging the pallet truck with the outrigger.

Ideally, the means provided on the outrigger for receiving and securing the pallet truck comprises a tilting connection carriage fastened to a lift carriage which is connected to the lifting means, the tilting connection carriage being further provided with a receptor and locking mechanism for receiving a hook provided on the pallet truck.

Conveniently, the connection carriage is provided with a pallet truck alignment system comprising angled plates that correctly guide the pallet truck to an aligned and centrally seated position.

Advantageously, the tilting connection carriage extends downwards so that the back plate may be lowered onto a truck or trailer bed such so that the pallet truck can be safely disconnected and driven from the connection carriage and into the rear of the truck or trailer.

Conveniently, the elevating means comprises at least one hydraulically or electrically operated lift mast member.

In a preferred arrangement, the elevating means comprises spaced apart lift mast members that remain stationary and a moveable lift carriage assembly to which the tilting connection carriage is connected, the moveable lift carriage assembly being hydraulically elevated along the spaced apart lift mast members.

In a preferred arrangement, the pallet truck is provided with a side-entry operator compartment having drive, steering, lift and other necessary controls.

Advantageously, the pallet truck and outrigger are provided with a CAN-BUS communication network with spring loaded complementary contacts fitted on the tilting connection carriage and on the rear of the pallet truck, so that when coupled together the pallet truck control inputs automatically switch to control the outrigger so that the traction and steering functions of the outrigger are controlled from pallet truck.

Ideally, the pallet truck and outrigger are each provided with a least one integrated steerable drive wheel.

Advantageously, the outrigger is provided with folding front mounts to which the ground engaging wheels are attached.

Optionally, there is also provided a means of stowing and securing the forklift to the rear of a truck or trailer comprising receptor pockets provided on the underside of the truck or trailer that are adapted to receive the lifting forks of the pallet truck and extensible supports upon which outrigger rests once it has been raised from the ground.

The invention will now hereinafter be described with reference to the accompanying drawings which show by way of example only, the main embodiment of a forklift in accordance with the invention.

In the drawings:

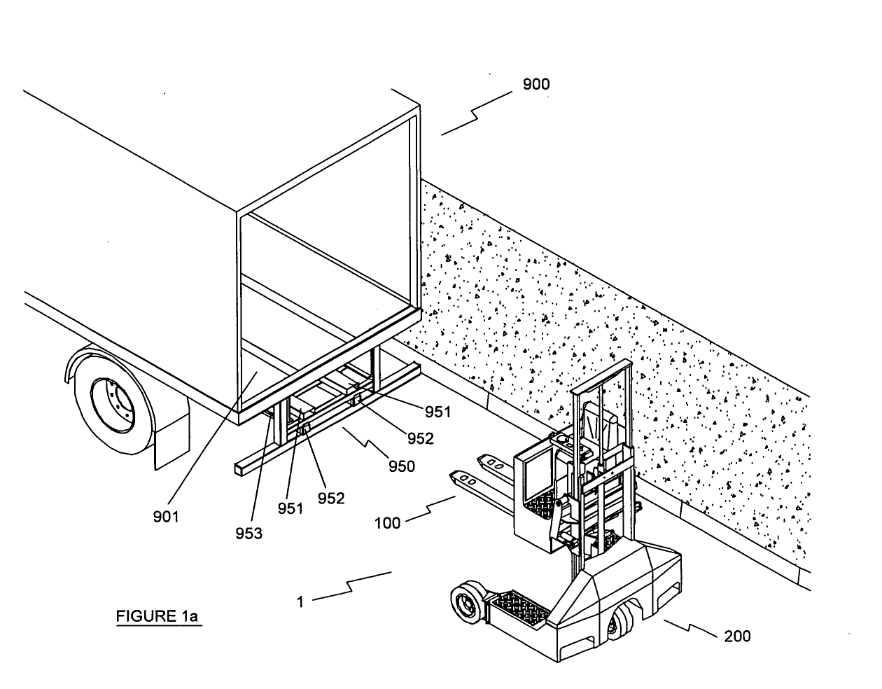

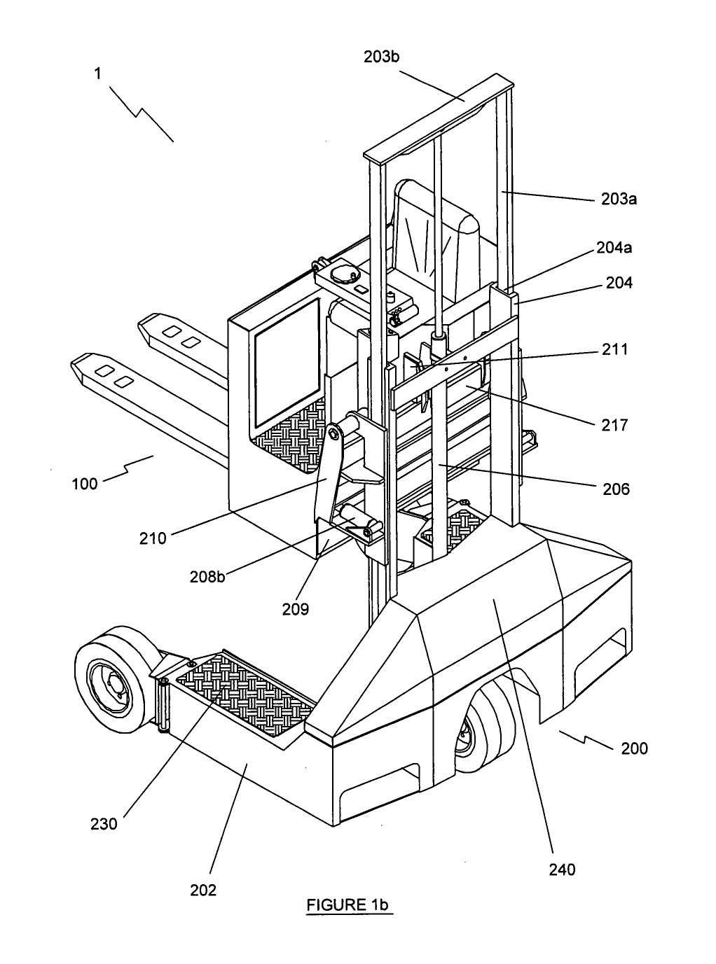

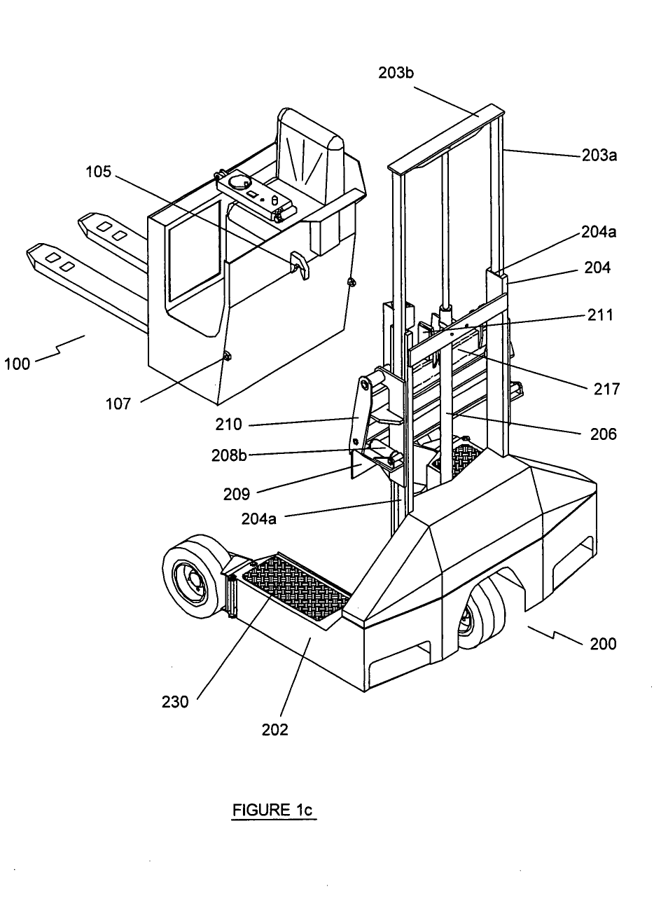

FIG. 1a is an isometric drawing a forklift and a trailer mounting attachment in accordance with the invention;

FIG. 1b is an enlarged isometric drawing a forklift in accordance with the invention;

FIG. 1c is an enlarged exploded, isometric drawing a forklift in accordance with the invention;

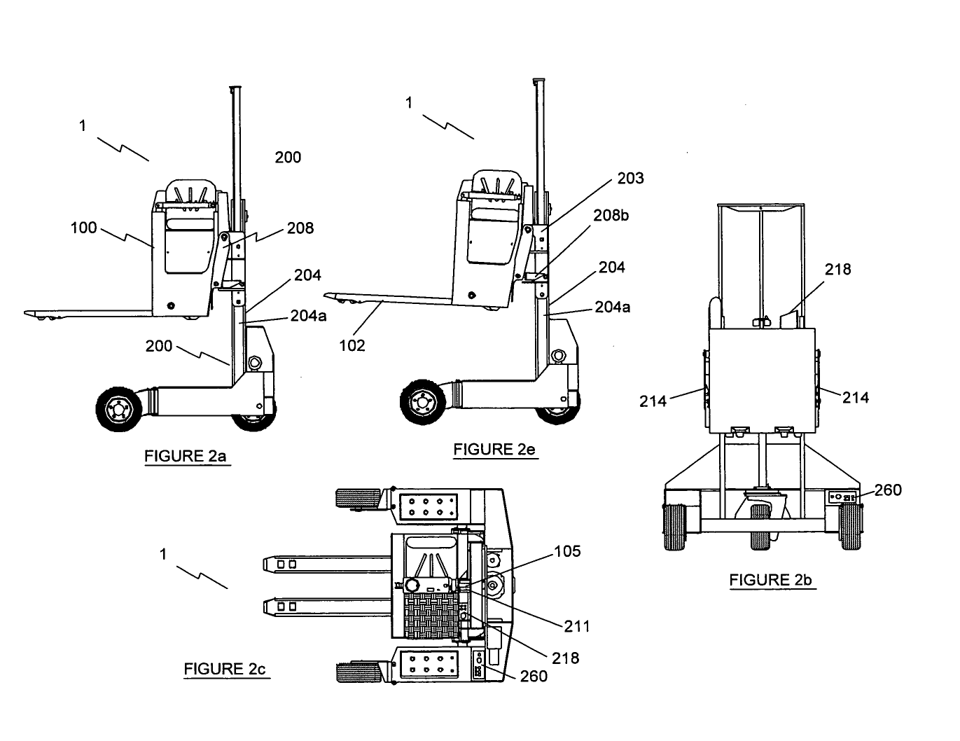

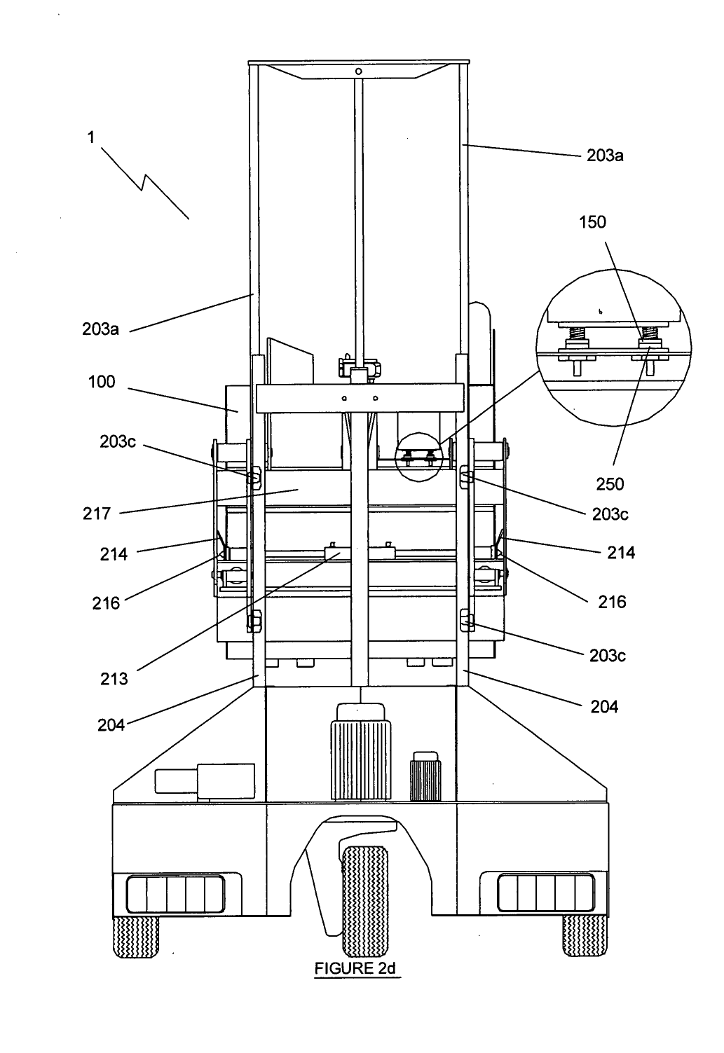

FIG. 2a is a side elevation of the forklift of the invention;

FIG. 2b is a front elevation of the forklift of the invention;

FIG. 2c is a plan view of the forklift of the invention;

FIG. 2d is an enlarged end elevation of the forklift of the invention;

FIG. 2e is a side elevation of the forklift of the invention shown in a tilted mode;

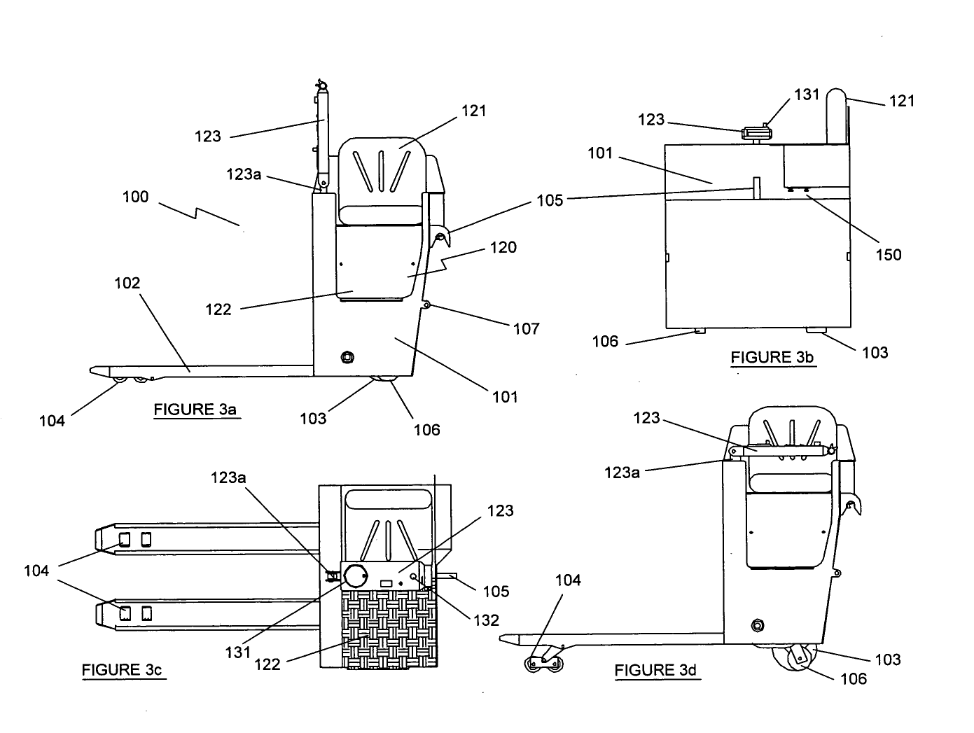

FIG. 3a is a side elevation of a pallet truck of the forklift shown in a lowered mode;

FIG. 3b is a end elevation of the pallet truck;

FIG. 3c is a plan view of the pallet truck;

FIG. 3d is a side elevation of the pallet truck shown in a raised mode;

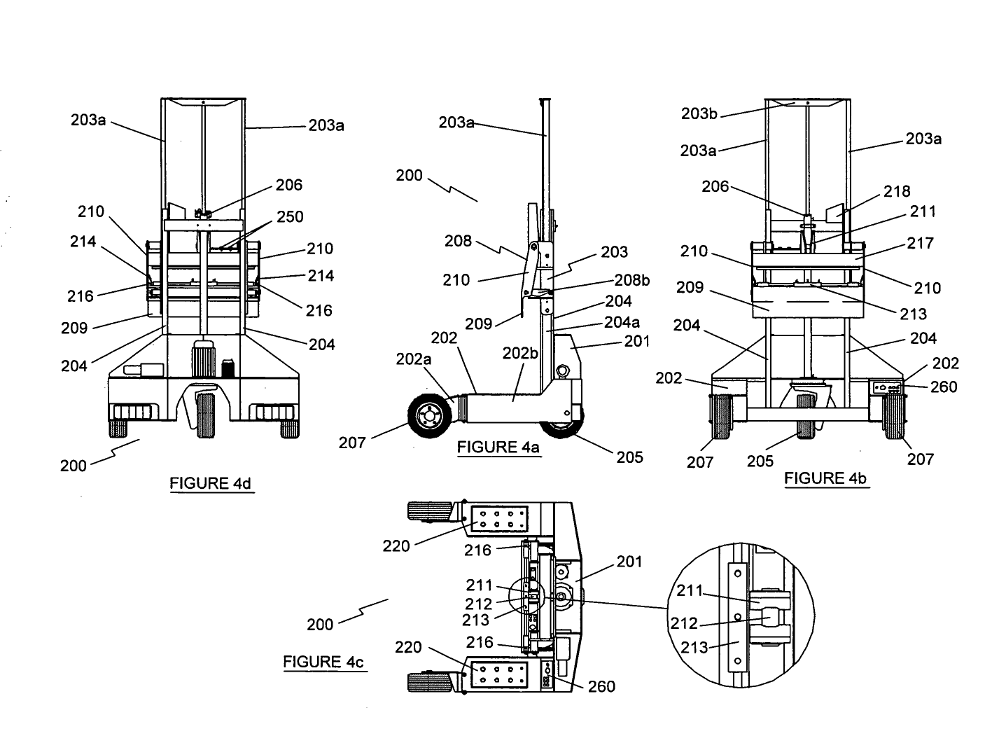

FIG. 4a is a side elevation of an outrigger of the forklift;

FIG. 4b is a front elevation of the outrigger;

FIG. 4c is a plan view of the outrigger;

FIG. 4d is an end elevation of the outrigger;

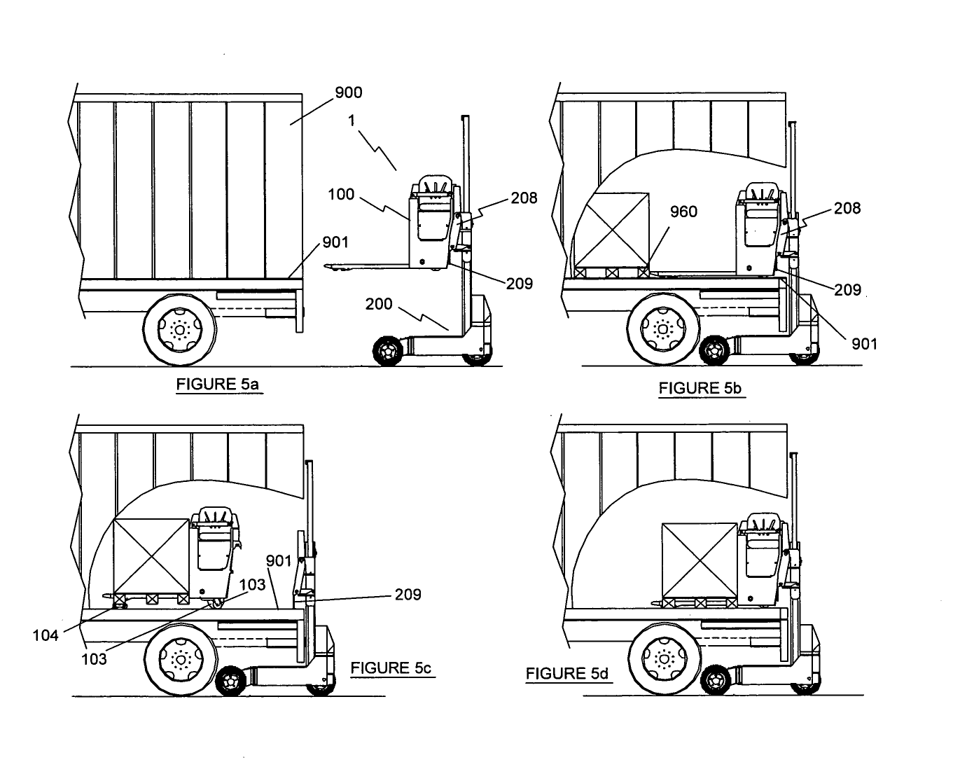

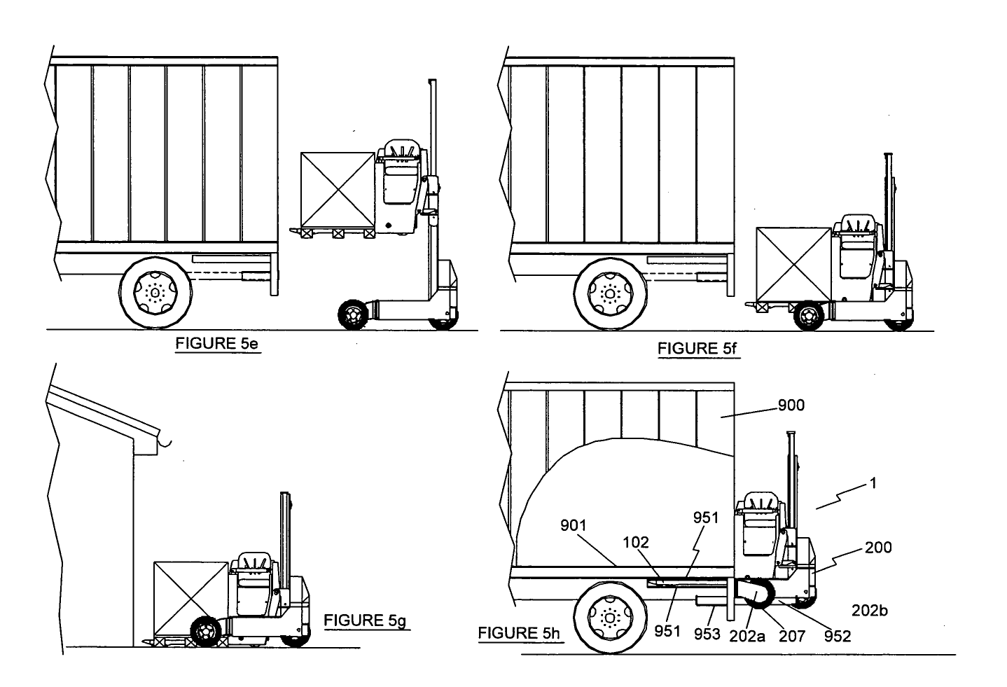

FIGS. 5a to 5g show schematically the operation of the forklift in accordance with the invention; and

FIG. 5h shows schematically the secure mounting of the forklift to the rear of a truck or trailer 900.

Referring initially to FIGS. 1a, 1b and 1c, a forklift 1 comprises a pallet truck 100 that is detachably coupled to an outrigger 200 such that the outrigger 200 can elevate pallet truck 100 to a desired working level from where the pallet truck 100, under control of an operator, can detach from the outrigger 200 and travel onto a raised platform such as the bed of a truck or trailer 901 or onto a loading bay. A means of mounting and securing the forklift 1 to a truck or trailer 900 is also provided and is indicated generally by the reference numeral 950.

Referring to FIG. 3a, FIG. 3b, FIG. 3c and FIG. 3d, a pallet truck 100 of the invention comprises a ride-on pallet truck having a body 101 having a side-entry operator compartment 120, lifting forks 102 coupling hook 105 and locking tabs 107. The body 101 is constructed around a strengthened frame and houses the battery, hydraulic power source, pallet truck lifting rams, electric drive and steering motors and the associated controllers, linkages and connections (not shown). Side-entry driver compartment 120 is provided with a seat 121, a foot well 122 and a retractable control panel 123.

Retractable control panel 123, upon which steering wheel 131 and lift controls 132 are located, is movably mounted to body 101 at position 123a such that said control panel 123 may be moved from an in use position that lies transverse the operator compartment 120 (FIGS. 3d and 3c) to an alternate position (FIG. 3a) whereby an operator may enter and exit driver compartment 120. Another version of retractable control panel 123 may include a transverse and horizontal retracted position obtained by mounting through a vertical pivot pin.

The transverse arrangement of the side-entry driver compartment 120 allows the body 101 to preserve compact overall dimensions and ensures that an operator's body and limbs are confined within these dimensions. The distal ends of lifting forks 102 are each provided with a pair of wheels 104. To enable pallet truck 100 to be highly manoeuvrable in confined spaces an integrated steerable drive wheel 103 is provided. Positioning of integrated steerable drive wheel 103 may either be centrally along the transverse axis of body 101 with caster type stabilizing wheels 106 located on either side to help maintain stability orin a preferred arrangement, integrated steerable drive wheel 103 may be positioned towards either edge of body 101 with a single caster type stabilizing wheel 106 located on the opposing edge of body 101. Wheels 103, 104 and 106 are provided with a common hydraulically or electrically operated means of raising and lowering (FIGS. 3d and 3a, respectively) which enables pallet truck 100 to lift and deposit pallets as well as to allow coupling hook 105 and locking tabs 107, which extend from the rear of body 101, to securely connect pallet truck 100 to outrigger 200 as shown in FIG. 2 and as described below.

It will be appreciated that the pallet truck 100 is not limited to having a side-entry driver compartment 120 and may be modified to accommodate a rear entry driver compartment with the necessary adjustments made to the positioning of retractable control panel 123, as well as the realignment of coupling hook 105 and locking tabs 107 to enable the pallet truck 100 to be securely connected to outrigger 200 via tilting connection carriage 208. Substantial changes to the outrigger lifting means would also be required to accommodate this arrangement.

Referring to FIG. 4a, FIG. 4b, FIG. 4c and FIG. 4d, the outrigger 200 of a forklift is provided with a U-shaped chassis comprising a rear support body 201, straddle legs 202, spaced apart lift mast members 204, a lift carriage 203, and a tilting connection carriage 208. Support body 201 spans the width of outrigger 200 and is provided with an integrated steerable drive wheel 205. Foldable straddle legs 202 extend perpendicularly from opposing ends of body 201. Each straddle leg 202 comprises a foldable portion 202a and a non-foldable portion 202b, the folding portions being provided with a wheel 207 at their respective distal ends. Motive power for outrigger 200 is provided by batteries 220 that are located on or within straddle legs 202 whereby said batteries also serve to enhance the stability triangle of forklift 1 thereby increasing its stability during use and in particular during use over sloping surfaces. Spaced apart lift mast members 204 comprise section members that extend upwardly from outrigger body 201 to which they are fixed at positions intermediate straddle legs 202. The opposing lift mast members 204 are arranged so their respective channel sections 204a face outwardly towards the sides of outrigger 200 as shown in FIG. 1b.

Lift carriage 203, which comprises upright side members 203a and upper cross-member 203b, is mounted substantially within channel sections 204a of spaced apart lift mast members 204. Inwardly facing bearings 203c (shown in FIG. 2d) which are attached to upright side members 203a and are disposed within channel sections 204a of spaced apart lift mast members 204, enable lift carriage 203 to slidably move upwardly and downwardly along said lift mast members. A hydraulic lift ram 206 which extends upwardly from outrigger body 201 and connects to upper cross-member 203b effects raising and lowering of lift carriage 203 along lift mast members204. It will be appreciated that alternative lifting means such as scissor-type lifts or alternate mast systems such as radial lifts or lift arms may be provided to raise lift carriage 203.

Tilting connection carriage 208, which comprises cross member 217, back plate 209 and side plates 210, is pivotally suspended at its upper end from lift carriage 203 such that actuation of tilt cylinders 208b which extend between respective side plates 210 and lift carriage 203 causes said connection carriage to tilt about its vertical axis (as illustrated in FIG. 2e). A control panel 218 provided at an elevated position above cross member 217 comprises controls for the lift, tilt and locking functions of tilting connection carriage 208. At this elevated position the controls are within convenient reach of an operator seated in a pallet truck 100 when coupled to outrigger 200 as shown in FIG. 2b. Tilting connection carriage 208, which is adapted to carry pallet truck 100, is further provided with a pallet truck alignment system comprising angled plates 214 that are positioned against side plates 210 at the bottom corners of tilting connection carriage 208 and above top surface of back plate 209. A hook receptor 211, which is adapted to receive a coupling hook 105 provided on the rear of a pallet truck 100, is located on the upper surface of cross member 217. Tilting connection carriage 208 is further provided with a user activated locking mechanism for engaging a pallet truck 100, the locking mechanism comprising locking pins 216 which are operated by an actuator 213 and extend outwardly into recesses provided at the lower portions of angled plates 214.

Referring to FIG. 2d, tilting connection carriage 208 is also provided with spring loaded contacts 250 which are adapted to engage with complimentary spring loaded contacts 150 provided on the rear of pallet truck 100 (shown in FIG. 3b) such that a CANbus (Controller Area Network bus) communication network is automatically or manually established once the truck 100 is coupled to the outrigger 200Using this arrangement, control over the traction and steering functions of the outrigger 200 are effected by the corresponding input controls provided on pallet truck 100.

Outrigger 200 is provided with an outer housing 240 (indicated in FIG. 1b) that encloses the hydraulic power source, lift controls, drive arm and steering motors and the associated controllers, linkages and connections. Panels 230 are also shown covering the batteries which are housed within straddle legs 202.

Referring now to FIG. 2a to FIG. 2e, forklift 1 is shown with ride-on pallet truck 100 coupled to outrigger 200. Pallet truck 100 enters tilting connection carriage 208 by reversing until the rear of pallet truck body 101 is in contact with cross member 217. Once pallet truck 100 has travelled fully into tilting connection carriage 208 the operator lowers the truck whereupon locking tabs 107 on pallet truck body 101 impinge against the angled plates 214 of the pallet truck alignment system thereby guiding the pallet truck 100 to a correctly aligned and centrally seated position. Once this position is correctly attained and pallet truck 100 is fully lowered, coupling hook 105 will have entered hook receptor 211 and thus engage with pin 212 as shown in FIG. 4c. Locking pins 216, which extend outwardly from actuator 213 pass through apertures provided in pallet truck locking tabs 107 and into recesses provided at the lower portions of angled plates 214 thereby locking the pallet truck in place. This locking mechanism prevents pallet truck 100 (and thus coupling hook 105) from moving upwardly and disengaging from pin 212 and thereby unhitching pallet truck 100 from outrigger 200. This feature is of particular importance during lifting operations and during mounting and securing of forklift 1 to a truck or trailer 900. Until such time when pallet truck 100 and outrigger 200 are correctly coupled together via tilting connection carriage 208, outrigger 200 is a passive vehicle incapable of traction and steering. However upon coupling, a switch provided on pallet truck 100 is triggered (either automatically or manually) thereby activating outrigger 200 with its traction and steering functions controlled via the corresponding input controls provided on the pallet truck 100 and which are communicated via a CANbus communication network enabled by complimentary spring loaded contacts 150, 250 provided on pallet truck 100 and connection carriage 208, respectively and as described previously. Alternatively, separate controls may be provided on outrigger 200 at a position within reach of an operator's left hand while seated on pallet truck 100. In FIG. 2e, the forklift 1 is shown in a tilted mode with tilt cylinders 208b extended and pallet truck forks 102 in an upwardly angled configuration. While coupled to the outrigger 200, pallet truck 100 is positioned intermediate the straddle legs 202 of said outrigger and the pallet truck forks 102 facing the same forward direction as said straddle legs.

Outrigger 200 is also provided with auxiliary controls 260 located on a straddle leg 202 which enables the lift and tilt functions of the lifting carriage 203 and the tilting connection carriage 208 as well as slow forward and rearward motion (i.e. “inching”) of the forklift 1 to be controlled by a user standing beside the forklift 1. Provision of said auxiliary controls 260 enables the forklift 1 to operated without the need of a driver seated in the pallet truck 100 and assists the operator during mounting and dismounting the pallet truck.

With reference to FIG. 5a to FIG. 5g, the use of the forklift will now be described.

An operator (not shown in the figures) seated in the pallet truck 100 which is coupled to outrigger 200 moves the forklift 1 to the rear of a vehicle 900 and raises the tilting connection carriage 208 of outrigger 200 to a height slightly above the level of the vehicle bed 901 (FIG. 5a). The operator then advances the forklift into the rear of the vehicle 900 so that back plate 209 of tilting connection carriage 208 is located at a position above vehicle bed 901, at which point the pallet truck 100 can be lowered onto its wheels on said vehicle bed (FIG. 5b). The operator then disconnects the pallet truck 100 from the outrigger 200 by disengaging locking pins 216 and further lowering tilting connection carriage 208 until the lower edge of back plate 209 rests on the vehicle bed 901 (FIG. 5c) whereupon pin 212 will have unlatched from coupling hook 105. This disconnecting action simultaneously deactivates outrigger 200 and applies a brake to prevent resultant backward motion of outrigger 200 as pallet truck 100 drives away from tilting connection carriage 208 and into the interior of the vehicle or container. Inside the vehicle 900, the lifting forks 102 are placed below a pallet 960 and are then raised through the deployment of the truck wheels (FIG. 5c). Pallet truck 100 is then reversed back onto tilting connection carriage 208 where it is re-coupled to outrigger 200 as described previously with reference to FIG. 2a to FIG. 2e. Once pallet truck 100 is re-coupled to outrigger 200, the operator can raise the lift carriage 203 until said pallet truck is lifted clear of the vehicle bed 901. By this stage the pallet truck's CANbus control of the outrigger 200 (and hence the entire forklift 1 assembly) is re-established through respective complimentary spring loaded contacts 150, 250 provided on pallet truck 100 and connection carriage 208, and the operator can release the brake on outrigger 200, reverse the forklift 1 from the rear of the vehicle 900 (FIG. 5e) and lower tilting connection carriage 208 to a more stable height (FIG. 5f) for driving forklift 1 to a warehouse or similar pallet repository (FIG. 5g).

Referring to FIG. 1a and FIG. 5h, mounting means 950 which is provided on the underside of a truck or trailer bed 901 to enable forklift 1 to be secured to the rear of a truck or trailer 900 comprises spaced apart elongate receptor pockets 951 adapted to receive lifting forks 102 and extensible supports 952 upon which outrigger 200 rests. An operator raises pallet truck 100 to the correct height and advances outrigger 200 towards the rear of truck 900 until lifting forks 102 fully enter elongate receptor pockets 951. As pallet truck 100 is now restrained from upward or downward motion, activation of the controls which would normally lower lift carriage 203 and tilting connection carriage 208 causes outrigger 200 to rise upwardly. Once wheels 207 have lifted from the ground the foldable portions 202a of straddle legs 202 are folded rearwardly against the sides of non-foldable portions 202b. Once outrigger 200 has been fully raised extensible supports 952 may be slid outwardly from guides 953 and placed beneath outrigger 200. Once extensible supports 952 are locked in place at both guides 953 and outrigger 200 ends, activation of the controls which would normally raise lift carriage 203 and tilting connection carriage 208 causes outrigger 200 to press downwardly against extensible supports 952 and thus increase the locking force between them, respectively.

It will be appreciated that further alternative embodiments of forklift 1 are possible which may include a double-stack version or version with clamping means, or versions with attachments for use with slip sheets or palletless systems.

It is thought that the present invention and its advantages will be understood from the foregoing description and it will be understood that the invention is not limited to the specific details described therein, which are given by way of example only and that various modifications and alterations are possible within the scope of the invention as defined in the appended claims.

1. A forklift truck for mounting on the rear of a carrying vehicle comprising an outrigger and a ride-on pallet truck;
the outrigger having:
a U-shaped chassis comprising a rear support body and a pair of straddle legs which extend forwardly from opposing ends of the support body, and each being provided with a ground engaging wheel located at the terminal end thereof, and the support body having a centrally mounted steerable drive wheel,
lifting means; and
a lifting carriage; and
the ride-on pallet truck including:
motive power means,
load engaging means, and
ground engaging wheels;
with the ride-on pallet truck being removably engageable with the lifting carriage of the outrigger.

2. A forklift truck as claimed in claim 1, wherein the ride-on pallet truck is removably engageable with the lifting carriage of the outrigger via a connection carriage.

3. A forklift truck as claimed in claim 2, wherein the connection carriage is provided with a means for engaging and disengaging with the ride-on pallet truck.

4. A forklift as claimed in claim 3, wherein the means for engaging and disengaging with the ride-on pallet truck comprises a pallet truck alignment system that is further provided with a means for locking engagement with a locking system provided on the pallet truck.

5. A forklift as claimed in claim 4, wherein the pallet truck alignment system comprises a plurality of angled plates fixed to the tilting connection carriage and a hook receptor provided on a cross member provided on the connection carriage; and wherein the angled plates and hook receptor are adapted to guide, locate and engage with the locking system provided on the ride-on pallet truck.

6. A forklift as claimed in claimed in claim 5, wherein the locking system provided on the ride-on pallet truck comprises a hook and a plurality of locking tabs disposed on the rear of the pallet truck body.

7. A forklift truck as claimed in claim 4, wherein the means provided on the pallet truck alignment system for locking engagement with the locking system provided on the ride-on pallet truck comprises locking pins which extend through apertures provided in locking tabs of pallet truck and into recesses provided in the angled plates.

8. A forklift truck as claimed in claim 7, wherein the locking pins extend outwardly from an activator and are deployed by controls provided on the ride-on pallet truck.

9. A forklift truck as claimed in claim 2, wherein the connection carriage is a tilting connection carriage.

10. A forklift truck as claimed in claim 9, wherein the tilting connection carriage is pivotally suspended on the lifting carriage.

11. A forklift truck as claimed in claim 10 wherein the tilting connecting carriage is provided with a means of tilting about its vertical axis.

12. A forklift truck as claimed in claim 11, wherein the means of tilting the connection carriage about its vertical axis comprises one or more tilting rams which extend between the connection carriage and the lifting carriage.

13. A forklift truck as claimed in claim 12, wherein the tilting connection carriage is provided with an elevated control panel whereby the lift, tilt and locking functions of tilting connection carriage are within convenient reach of an operator seated in pallet truck when coupled to the outrigger.

14. A forklift truck as claimed in claim 1, wherein the ride-on pallet truck comprises a side-entry operator compartment.

15. A forklift truck as claimed in claim 14, wherein the ride-on pallet truck is provided with a retractable control panel that is movably mounted to said pallet truck such that the said control panel may be moved from an in use position transverse the operator compartment to an alternate position whereby an operator can enter and exit said operator compartment.

16. A forklift truck as claimed in claim 1, wherein the ground-engaging wheels of ride-on pallet truck are each provided with a means of raising and lowering thus enabling said pallet truck to lift and deposit pallets as well as to allow coupling hook and locking tabs to enter and engage with the pallet truck alignment system provided on the connection carriage.

17. A forklift truck as claimed in claim 1, wherein the ride-on pallet truck is positioned intermediate the straddle legs of the outrigger while in engagement with said outrigger, and wherein the load engaging means face the same forward direction of the straddle legs while in engagement with said outrigger.

18. A forklift truck as claimed in claim 1, wherein ride-on pallet truck and outrigger are each provided with a communication means wherein control of the outrigger is controlled by the operator of the ride-on pallet truck 100 when said pallet truck is coupled to said outrigger.

19. A forklift truck as claimed in claim 18, wherein the communication means provided between the ride-on pallet truck and the outrigger is a CANbus communication network.

20. A forklift truck as claimed in claim 19, wherein CANbus control signals are communicated from the ride-on pallet truck to the outrigger via contacts provided on the ride-on pallet truck and the outrigger, respectively.

21. A forklift truck as claimed in claim 20, wherein contacts provided on the ride-on pallet truck and the outrigger are spring loaded contacts.

22. A forklift truck as claimed in claim 1 wherein the spaced apart lift members each comprise a channel section member wherein the channel sections are arranged to face outwardly towards the sides at outrigger.

23. A forklift truck as claimed in claim 1 wherein the lifting carriage is provided with side members having inwardly facing bearings that in use are disposed within channel sections spaced apart lift members.

24. A forklift truck as claimed in claim 1, wherein the ground engaging wheels located at the terminal ends of outrigger straddle legs are mounted on foldable mounts.

25. A forklift truck as claimed in claim 1, wherein motive power for outrigger is provided by batteries that are located on or within straddle legs.

26. A forklift truck as claimed in claim 1, wherein a control panel provided on the outrigger chassis enables a user standing proximate forklift 1 to control said forklift.

27. A forklift truck as claimed in claim 1, wherein the forklift truck is provided with a means for stowing and securely mounting to the rear of a carrying vehicle, the stowing and mounting means comprising:
a plurality of spaced apart elongate receptor pockets provided on the underside of the carrying vehicle; and
extensible supports which can slidably deployed from guides provided on the underside of the carrying vehicle;
characterised in that the elongate receptor pockets are adapted to receive the lifting forks of ride-on pallet truck and extensible supports are adapted to engaged with the underside of outrigger once raised from the ground.

28. A forklift truck as claimed in claim 1 in which the lifting means includes a vertical lift mast comprising two spaced apart lift members, and the lifting carriage which is slidably mountable on the spaced apart lift members.

29. A forklift truck as claimed in claim 28 in which the vertical lift mast is integrated with the chassis of the outrigger.

30. A forklift truck as claimed in claim 1 which is mountable on the rear of a carrying vehicle.

31. A forklift truck as claimed in claim 1 in which the motive power means is an internal combustion engine.

32. A forklift truck as claimed in claim 1 which has at least 3 ground engaging wheels.

33. A forklift as claimed in claim 32 which has at least 4 ground engaging wheels.
